(19) United States
(12) Patent Application Publication
(10) Pub. No.: US 2025/0332742 A1
(43) Pub. Date: Oct. 30, 2025

(54) GRIPPER SET AND GRIPPING APPARATUS ASSEMBLED THEREFROM

(71) Applicant: J.Schmalz GmbH, Glatten (DE)

(72) Inventors: Ralf Stockburger, Glatten (DE); Hermann Reinisch, Dornhan (DE); Tobias Schleeh, Altensteig (DE)

(73) Assignee: J.Schmalz GmbH, Glatten (DE)

(21) Appl. No.: 19/192,688

(22) Filed: Apr. 29, 2025

(30) Foreign Application Priority Data
Apr. 30, 2024 (EP) 24 173 471.4-1002

(51) Int. Cl. B25J 15/06

(52) U.S. Cl. CPC B25J 15/0658

(57) ABSTRACT

A gripper set comprising at least two gripper blocks and at least one intermediate piece provided separately from the gripper blocks for transmitting operating fluid, negative pressure and/or positive pressure, between the gripper blocks.

The invention relates to the field of gripping apparatuses, in particular suction gripping apparatuses.

Gripping apparatuses are known in many different ways from the prior art. For example, suction grippers are known which have a plurality of gripping units, each comprising a displaceable lifting piston and a suction gripper coupled in motion to the lifting piston. With such suction grippers, it is possible to flexibly adapt the suction gripper to different geometries of objects to be gripped by selectively extending individual gripping units.

The invention addresses the problem of creating a cost-effective and flexibly adaptable gripping solution for gripping objects of different geometries. A compact and simple design is desirable.

This problem is solved in accordance with the invention by a gripper set having the features of claim 1. The gripper set is particularly designed for assembling a gripping apparatus.

The gripper set comprises at least two gripper blocks and at least one intermediate piece, in particular provided separately from the gripper blocks.

The at least one intermediate piece is designed to transmit operating fluid, in particular negative pressure and/or positive pressure, between two gripper blocks connected by the intermediate piece.

The intermediate piece is preferably repeatably connectable to a gripper block, non-destructively detachable and reconnectable. When assembled, two adjacent gripper blocks are each connected by an intermediate piece.

The gripper blocks each have a main body and at least one, preferably two or more, gripping units held on the main body for gripping an object.

A respective gripping unit (in the case of several gripping units, each gripping unit) comprises a lifting piston and a gripper, in particular a suction gripper coupled in motion to the lifting piston. The lifting piston (and thus the gripper) is adjustable along a lifting axis between an axially retracted configuration and an axially extended configuration relative to the main body. The at least one gripping unit can be operated by operating fluid. In particular, the lifting piston can be transferred from a retracted configuration to an extended configuration along the lifting axis by applying operating fluid. In particular, the gripping effect of the gripper can be activated by applying operating fluid to the gripper.

The main body has at least one integrated operating fluid distribution system for distributing operating fluid. The at least one gripping unit can be supplied with operating fluid via the at least one operating fluid distribution system. In particular, a first operating fluid distribution system, preferably a compressed air distribution system, can be provided for driving a displacement movement of the lifting piston along the lifting axis. Alternatively or additionally, a second operating fluid distribution system, preferably a negative pressure distribution system, can be provided for operating the gripper, in particular the suction gripper.

To couple the intermediate piece, the gripper blocks each have an intermediate piece coupling point on each coupling side. In particular, each gripper block has two intermediate piece coupling points, which are preferably formed on opposite coupling sides of the gripper block. This makes it possible to connect several gripper blocks, especially more than two gripper blocks, in series. The coupling sides can in particular be the front sides of the gripper blocks.

At least one operating fluid opening of the at least one operating fluid distribution system opens out at the intermediate piece coupling point (at each intermediate piece coupling point if there are several intermediate piece coupling points). In particular, a negative pressure opening of the at least one negative pressure distribution system opens out at a respective intermediate piece coupling point. In addition, a compressed air opening of the at least one compressed air distribution system can open out at a respective intermediate piece coupling point.

The intermediate piece has at least one operating fluid channel, in particular a number of operating fluid channels corresponding to the number of operating fluid openings at the intermediate piece coupling point for the transmission of operating fluid between the gripper blocks. In particular, the intermediate piece has at least one negative pressure channel and/or at least one compressed air channel.

The at least one operating fluid channel is designed and arranged such that the operating fluid channel is fluidically connected to the at least one operating fluid opening in the coupled state of the intermediate piece at the intermediate piece coupling point. In particular, each operating fluid channel is assigned an operating fluid opening, so that a respective operating fluid channel is fluidically connected to the operating fluid opening assigned to it in the coupled state of the intermediate piece at the intermediate piece coupling point.

Such a gripper set with gripper blocks and media-carrying intermediate piece enables a simple modular construction of a gripping apparatus, so that, for example, gripping apparatuses of different configurations can be easily assembled depending on the application situation. For example, it is conceivable that a plurality of gripper blocks are provided and, depending on a handling task, e.g., depending on an object to be gripped, more or fewer gripper blocks are connected to one another. Because the intermediate piece is media-conducting, the usually time-consuming fluidic connection of several gripping modules can be dispensed with. The transmission of operating fluid via the intermediate piece also has the advantage that not every gripper block has to be connected to an external operating fluid supply. In this way, for example, supply lines and thus possible interference contours can be reduced when gripping.

The intermediate piece can be formed in one piece with a gripper block. In particular, each gripper block can have an intermediate piece. For example, the intermediate piece can be molded onto the main body of the gripper block, e.g., by injection molding onto the main body. In particular, it is conceivable that the gripper blocks each have an intermediate piece coupling point on a first coupling side and have the intermediate piece, for example molded on, on a second coupling side opposite the first coupling side.

Preferably, however, the at least one intermediate piece is provided separately from the gripper blocks. In this respect, the gripper set can comprise in particular at least three initially separate parts (a first gripper block, an intermediate piece and a second gripper block), which can then be assembled to form a gripping apparatus. Preferably, the gripper set comprises n grippers and n−1 intermediate pieces. In particular, the intermediate piece can be designed to be repeatably connectable to, non-destructively detachable from, and reconnectable to two gripper blocks.

Preferably, the at least one operating fluid distribution system comprises a negative pressure distribution system for distributing negative pressure. In particular, the main body may have a negative pressure connection for connection to a negative pressure supply. Alternatively or additionally, the at least one operating fluid distribution system may comprise a compressed air distribution system for distributing compressed air. In particular, the main body can have a compressed air connection for connection to a compressed air supply. It is particularly preferred if the at least one operating fluid distribution system comprises both at least one negative pressure distribution system and a compressed air distribution system, i.e., the main body has both at least one negative pressure distribution system and a compressed air distribution system.

The intermediate piece coupling point and intermediate piece can be designed such that the intermediate piece is held in a coupled state at the intermediate piece coupling point, in particular is firmly connected to the gripper block. The intermediate piece coupling point and intermediate piece can also be designed in such a way that the intermediate piece is only loosely connected to the main body in a coupled state.

Preferably, the intermediate piece is designed to be insertable into the main body. It is conceivable, for example, that the intermediate piece has one or more fastening pins which can be inserted into corresponding recesses on the main body of a respective gripper block.

In an advantageous development, the intermediate piece coupling point is designed as an intermediate piece receptacle into which the intermediate piece can be inserted or plugged at least in portions. Such a design facilitates assembly and disassembly. In particular, the intermediate piece can be inserted or plugged into the intermediate piece receptacle without the need for tools.

In an advantageous embodiment, the intermediate piece receptacle can be designed as a recess or depression on the main body, in particular on an outer wall of the main body. Furthermore, it may be advantageous if the intermediate piece receptacle is designed in such a way that when two gripper blocks are coupled via an intermediate piece arranged therebetween, the main bodies of the two gripper blocks, in particular a respective housing portion which surrounds the intermediate piece receptacle, abut one another. In this way, a particularly compact arrangement is created. In addition, with such an embodiment, the intermediate piece is protected from environmental influences, which promotes reliable, leak-free transmission of operating fluid.

Preferably, the intermediate piece receptacle has a contact surface for the contact of the intermediate piece. The contact surface can be arranged orthogonally to an insertion or plug-in direction. The contact surface can form a stop for the intermediate piece. If the intermediate piece receptacle is designed as a recess, the contact surface can be formed, for example, by a bottom surface of the recess.

One or more recesses may be provided on the contact surface to accommodate the fastening pins mentioned above.

The at least one operating fluid opening can be separated from the contact surface, in particular open out at a coupling surface separated from the contact surface.

However, it is particularly preferred if the at least one operating fluid opening opens out into the contact surface.

In this way, a particularly compact design of the intermediate piece coupling point is created. In addition, a leak-free connection between the gripper block and the intermediate piece is promoted.

A fluidic connection between an operating fluid opening of the gripper block and an operating fluid channel of the intermediate piece associated with the operating fluid opening can be established in different ways.

It is conceivable, for example, that the operating fluid channel has a channel opening on a coupling side of the intermediate piece, which channel opening, in the coupled state of the gripper block and intermediate piece, is aligned with the operating fluid opening assigned to the operating fluid channel at the intermediate piece coupling point. In particular, the intermediate piece can be inserted into the intermediate piece receptacle in such a way that the channel opening is aligned with the operating fluid opening.

To seal a fluidic connection between the channel opening or operating fluid channel and the associated operating fluid opening, appropriate seals can be provided at the intermediate piece coupling point and/or on the intermediate piece itself. It is also conceivable that the intermediate piece as a whole is made of a sealing material, e.g., a plastic, in particular elastomer. It may then be advantageous if the intermediate piece has a material portion enclosing the channel opening of the at least one operating fluid channel, which material portion forms a sealing portion. A second sealing portion enclosing the at least one operating fluid channel opening can then optionally be provided at the intermediate piece coupling point, for example in the form of a sealing receptacle for receiving the first sealing portion.

In a particularly advantageous development, a respective operating fluid channel of the intermediate piece can be surrounded by a connecting pin. The connecting pin is preferably designed such that it can be inserted into the operating fluid opening associated with the operating fluid channel and thus, in particular, a fluidic connection can be established between the operating fluid distribution system and the operating fluid channel. For example, the operating fluid opening can be formed as a recess in the main body, in particular on the contact surface of the intermediate piece receptacle, into which the connecting pin can be inserted. In this way, a holding function can be provided on the one hand. For example, it is conceivable that the intermediate piece is held on the gripper block via at least one connecting pin. However, this does not exclude the possibility that the intermediate piece may have additional fastening pins (see above) which serve only a holding function. On the other hand, by inserting the connecting pin into the operating fluid opening, for example, the alignment of the intermediate piece can be simplified (centering function).

It can be particularly advantageous if the intermediate piece is designed in such a way that the operating fluid channel is sealed by inserting the connecting pin into the operating fluid opening. The connecting pin can thus be accommodated in the operating fluid opening in a sealing manner for the operating fluid channel.

This can be achieved, for example, by providing a first sealing portion surrounding the connecting pin on the intermediate piece, which first sealing portion interacts with a second sealing portion surrounding the operating fluid opening at the intermediate piece coupling point. For example, the first or the second sealing portion can be formed by a seal, e.g., a sealing ring, and the other sealing portion can be designed as a sealing surface for the seal to rest on or as a sealing receptacle for receiving the seal.

However, it is also conceivable that the connecting pin or the intermediate piece as a whole is made of a sealing material, e.g., a plastic, in particular elastomer. When inserting the connecting pin into the operating fluid opening, the connecting pin can then, for example, bear sealingly against a wall surrounding the operating fluid opening.

In embodiments in which the intermediate piece is provided separately from the gripper blocks, the intermediate piece preferably has a first coupling side for connection to an intermediate piece coupling point of a first gripper block and an opposite second coupling side for connection to an intermediate piece coupling point of a second gripper block. The at least one operating fluid channel then preferably extends from the first coupling side to the second coupling side. In particular, the operating fluid channel can be delimited on a first side of the intermediate piece by a first connecting pin which protrudes in a first direction, and can be surrounded on an opposite second side of the intermediate piece by a second connecting pin which protrudes in a second direction opposite the first direction.

The first and second coupling sides of the intermediate piece can be identical to each other. In particular, the intermediate piece coupling points can then also be designed identically to one another.

The first and second coupling sides of the intermediate piece can also be different. In this way, the risk of incorrect assembly can be further reduced. This can be particularly advantageous if certain interfaces can be connected only unidirectionally, e.g., the electrical interface described below.

In particular, it is then conceivable that a first intermediate piece coupling point for connection to the first coupling side of the intermediate piece and—on an opposite side—a second intermediate piece coupling point for connection to the second coupling side of the intermediate piece, are provided on a respective gripper block.

In a particularly advantageous development, the intermediate piece can also have an electrical interface. The electrical interface can be designed to transmit data. In this respect, the electrical interface can be a data interface. Alternatively or additionally, the electrical interface can be designed to transmit current.

Preferably, an electrical coupling point is then also provided at the intermediate piece coupling point for interaction with the electrical interface of the intermediate piece. The electrical coupling point and the electrical interface can, for example, be designed as a plug/socket system.

For example, it is conceivable that each gripper block has its own control device. The control device of a gripper block can then be connected to the electrical coupling point of the gripper block electrically and/or for data exchange. When coupled together, the control devices of adjacent gripper blocks can then be connected to one another via the electrical interface of the intermediate piece electrically and/or for data exchange.

Furthermore, it may be advantageous if the intermediate piece has sensors for monitoring a gripping state of the at least one gripping unit of a gripper block connected to the intermediate piece. For example, it is conceivable that the intermediate piece has a pressure sensor which is designed to measure an operating pressure prevailing in an operating fluid channel (and thus an operating pressure in the operating fluid distribution system).

Within the scope of an advantageous development, the gripper set can also comprise at least one cover piece, in particular in the form of a cover plate, which is designed to cover an intermediate piece coupling point which is not occupied by an intermediate piece. In the assembled state, intermediate piece receptacles of the gripper blocks that are not occupied by an intermediate piece can be covered by a cover piece, in particular a cover plate.

The cover piece is designed in particular to seal at least one operating fluid opening, in particular all operating fluid openings.

The gripper of the at least one gripping unit can fundamentally be designed differently. For example, the gripper can be a mechanical gripper or a magnetic gripper. In such embodiments, the operating fluid can in particular serve to adjust the lifting piston along the lifting axis, in particular to transfer it from the retracted configuration to the extended configuration.

However, it is particularly preferred if the gripper is a suction gripper for sucking against an object. In this respect, the gripping unit is preferably a suction unit and the gripper blocks are suction blocks.

The invention therefore also relates in particular to a suction gripper set comprising
at least two suction blocks, each comprising a main body with at least one integrated operating fluid distribution system, in particular a negative pressure distribution system, for distributing operating fluid, and
at least one suction unit which can be supplied with operating fluid, in particular a negative pressure, via the operating fluid distribution system, in particular negative pressure distribution system, wherein the suction unit comprises a lifting piston which can be extended and retracted along a lifting axis and a suction gripper which is coupled in motion to the lifting piston,
at least one intermediate piece, in particular provided separately from the suction blocks, for transmitting operating fluid, in particular negative pressure and/or positive pressure, between two suction blocks connected by the intermediate piece,
wherein each suction block has an intermediate piece coupling point for coupling an intermediate piece on a respective coupling side, in particular on two opposite sides in each case, wherein an operating fluid opening of the at least one operating fluid distribution system opens at the intermediate piece coupling point, wherein the intermediate piece has an operating fluid channel, in particular a negative pressure channel and/or compressed air channel, such that the operating fluid channel is fluidically connected to the operating fluid opening in the coupled state of the intermediate piece at the intermediate piece coupling point.

In an embodiment with suction grippers, it can be advantageous if the at least one operating fluid distribution system comprises at least one negative pressure distribution system, in particular a separate negative pressure distribution system for each suction unit, and optionally a compressed air distribution system. In particular, at least one negative pressure opening of the at least one negative pressure distribution system, in particular a number of negative pressure openings corresponding to the suction units, and optionally at least one compressed air opening of the compressed air distribution system can open at a respective intermediate piece coupling point. The intermediate piece then comprises in particular at least one negative pressure channel, in particular a number of negative pressure channels corresponding to the number of negative pressure openings, and optionally at least one compressed air channel.

Preferably, both a negative pressure distribution system (for supplying the suction grippers with negative pressure) and a compressed air distribution system (for supplying the lifting piston with compressed air) are provided.

In particular, the main body of at least one gripper block/suction block can then have a negative pressure connection for connection to an external negative pressure supply. Optionally, the main body of at least one suction block can have a compressed air connection for connection to an external compressed air supply.

In a particularly advantageous embodiment, the intermediate piece has at least one negative pressure channel, at least one positive pressure channel and at least one electrical interface.

In an embodiment with a suction gripper, this can preferably be supplied with negative pressure through the lifting piston, for example via a negative pressure channel provided in the lifting piston. Preferably, the at least one gripping unit is designed such that in the retracted configuration of the lifting piston a negative pressure supply to the suction gripper (in particular a flow path between the negative pressure channel in the lifting piston and the negative pressure distribution system) is interrupted, and in the active configuration this flow path is released.

It is conceivable that all gripper blocks of the gripper set are identical to each other. In particular, at least the main bodies of the gripper blocks can be designed identically to one another. This enables cost-effective production because standard components can be used. In order to optionally implement different functions, the main bodies can then be modified, for example, by additional components. For example, it is conceivable that all main bodies have an operating fluid connection, but only one main body has this connection open and the connections of the other main bodies are closed by a sealing plug.

It is also conceivable that different gripper block types are provided. For example, it is conceivable that at least one gripper block of the gripper set is designed as a feed block comprising at least one operating fluid connection, in particular a negative pressure connection and/or a compressed air connection. Further gripper blocks can then, for example, be designed as extension blocks without at least one operating fluid connection of their own, or, for example, have only a compressed air connection but no negative pressure connection.

The above-mentioned object is also achieved by a gripping apparatus for gripping an object, wherein the gripping apparatus is assembled from at least one of the gripper sets described above. The gripping apparatus comprises at least two gripper blocks, wherein adjacent gripper blocks are connected by an intermediate piece. The gripping apparatus preferably has n grippers and n−1 intermediate pieces.

The advantages and optional features described above with respect to the gripper set can also be used to design the gripping apparatus so that reference is made to the above disclosure in this respect in order to avoid repetitions.

The gripping apparatus preferably comprises at least two gripper blocks which are fluidically coupled to one another via an intermediate piece. The intermediate piece is arranged in particular between the first gripper block and the second gripper block.

In particular, the intermediate piece is coupled with its first coupling side to an intermediate piece coupling point of the first gripper block and with its second coupling side to an intermediate piece coupling point of the second gripper block.

In an advantageous development, the gripping apparatus can have a third gripper block, wherein the third gripper block is coupled to the second gripper block via a further, second intermediate piece.

It is conceivable that operating fluid, in particular negative pressure, is passed through the two intermediate pieces between all three suction blocks. However, it is also conceivable that, for example, at least one operating fluid channel, in particular at least the at least one negative pressure channel, of the second intermediate piece is closed in a fluid-tight manner. In this way, segmentation of the gripping apparatus is possible.

In such an embodiment, for example, one of the first and second gripper blocks can have an operating fluid connection, in particular a negative pressure connection, and in addition the third gripper block or a further gripper block optionally connected to the third gripper block via a third intermediate piece can have a further operating fluid connection, in particular a negative pressure connection.

The gripper blocks can only be connected to each other by the intermediate piece. Preferably, however, the gripper blocks are attached to a common support, e.g., a flange plate of a manipulator. For this purpose, the main bodies can have at least one fastening portion for fastening to a support, for example a flange plate of a manipulator.

Further advantageous developments of the gripper blocks are described below, which can be provided independently of the features mentioned above.

The main body of each gripper block can be formed of one or more parts. Preferably, the main body is monolithic. In particular, the at least one operating fluid distribution system is defined by a monolithically formed portion of the main body.

The extension and retraction of the lifting piston of a respective gripping unit can, in essence, be carried out in different ways. Preferably, the lifting piston is pressure-operated, in particular compressed air-operated, and can be transferred from the retracted configuration to the extended configuration. In this respect, the lifting piston can be adjusted along the lifting axis by applying a pressure (negative pressure or positive pressure) effective along the lifting axis.

Particularly preferred are embodiments in which the lifting piston can be displaced in the extension direction by applying compressed air, in particular can be transferred from the retracted passive configuration into the extended active configuration. For example, the lifting piston can be displaceable in a gripping unit housing, wherein at least one pressure chamber is provided in the gripping unit housing, by applying compressed air to which a force is exerted on the lifting piston in the extension direction.

In particular, the at least one operating fluid distribution system of a respective gripper block then comprises a compressed air distribution system for directing compressed air to the lifting pistons.

Within the scope of an advantageous development, each gripper block can also have a compressed air valve device which is designed to control a compressed air supply to the lifting piston, in particular to the optionally several lifting pistons independently of one another. The compressed air valve device can in particular have a separate compressed air valve for each gripping unit. Preferably, the compressed air valve device is provided in the main body. The above-mentioned optional control device can in particular be designed to control the compressed air valve device.

The at least one gripping unit can be designed such that the lifting piston is biased, in particular spring-loaded, into the retracted configuration. In particular, the lifting piston may be in the retracted configuration in an initial configuration.

The lifting piston of a gripping unit is preferably mounted in a gripping unit housing of the gripping unit. The gripping unit housing can extend longitudinally along the lifting axis, which facilitates a compact arrangement of several gripping units next to each other. The gripping unit housing can be formed in one or more parts. The gripping unit housing can be formed at least in portions by the main body. The gripping unit housing can be provided separately from the main body, at least in portions, and fastened to the main body.

The lifting piston can be mounted about the lifting axis in a manner that prevents it from rotating. For example, it is conceivable that an anti-rotation device is implemented using interacting circle segments. Such an anti-rotation device therefore does not have a clamping effect.

The gripper blocks can also comprise one or more sensors. For example, sensors can be provided to monitor a displacement position (retracted configuration/extended configuration) of the lifting piston. Alternatively or additionally, at least one sensor can be provided for distance monitoring or collision warning. The sensors can be connected to the optional control device and can be controlled thereby.

It is conceivable that each gripper block has only one gripping unit. Preferably, however, a plurality of gripping units per gripper block is provided. It may then be advantageous if the gripping units are mounted on the main body in such a way that the lifting axes of the gripping units run parallel to each other. In this way, a particularly compact arrangement is created, which is particularly suitable for gripping planar components such as sheet metal. Preferably, the lifting pistons of the gripper blocks can then be operated independently of one another, i.e., extended and retracted. In this respect, individual gripping units can be activated selectively.

The invention is explained in more detail below with reference to the figures. In the drawings:

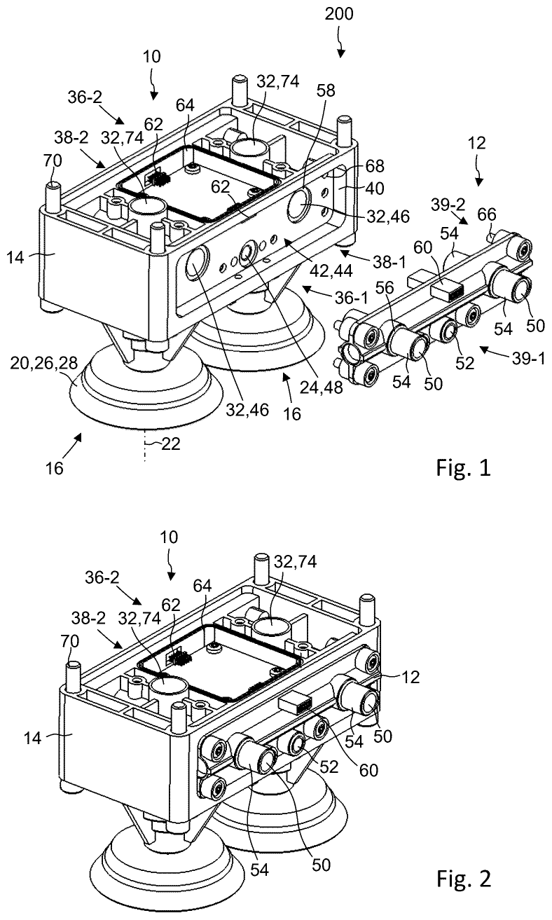

FIG. 1 is a sketched representation of an exemplary embodiment of a gripper set comprising a gripper block and an intermediate piece;

FIG. 2 is a gripper set according to FIG. 1, wherein the intermediate piece is inserted into an intermediate piece coupling point of the gripper block;

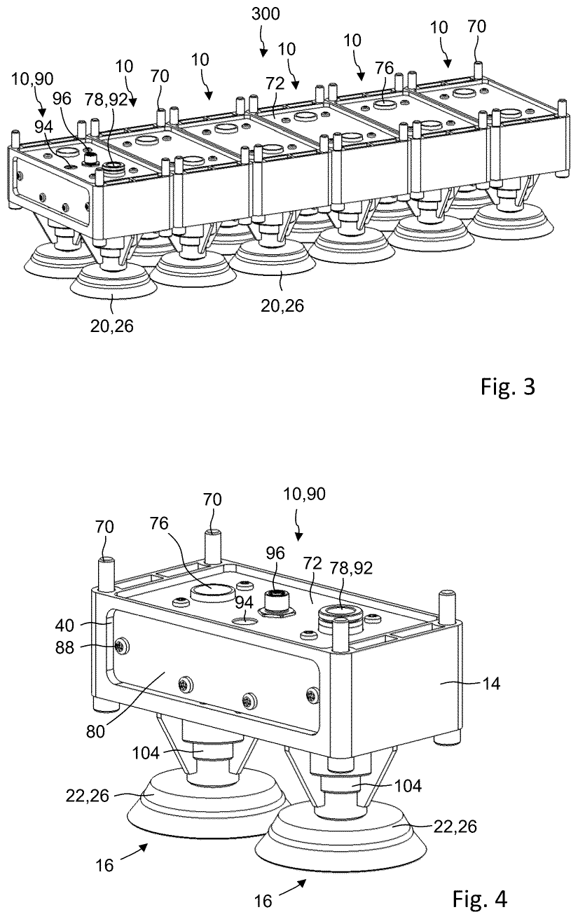

FIG. 3 is a sketched representation of an exemplary embodiment of a gripping apparatus assembled from several gripper sets comprising several gripper blocks which are connected to one another via intermediate pieces;

FIG. 4 is a sketched representation of a gripper block in which an intermediate piece coupling point is covered by a cover piece; and

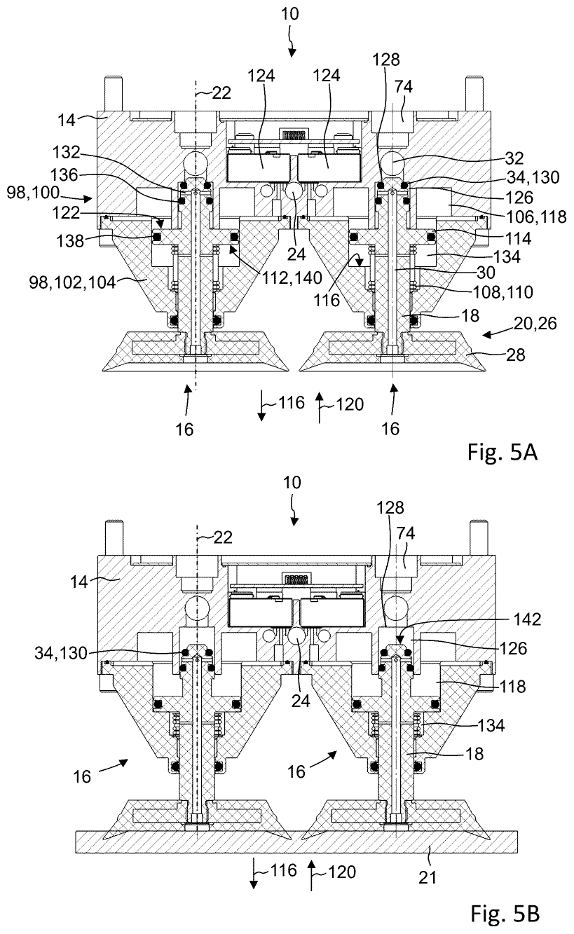

FIG. 5A, B show sectional views of the gripper block according to FIG. 1 to explain the functioning of the gripping units, with the lifting piston in the retracted passive configuration (view A) and the extended active configuration (view B).

FIG. 1 shows an exemplary embodiment of a gripper set, which is denoted as a whole by reference sign 200. The gripper set 200 comprises a gripper block 10 and an intermediate piece 12 for transmitting operating fluid between the gripper block 10 and another gripper block 10 (not shown in FIG. 1). In embodiments not shown, the gripper set 200 can also comprise more gripper blocks and more intermediate pieces 12.

An exemplary embodiment of a gripping apparatus assembled from several gripper blocks 10 and intermediate pieces 12 is shown in FIG. 3 and is designated overall by reference sign 300.

Each gripper block 12 comprises a main body 14 and two gripping units 16 held thereon. In embodiments not shown, more or fewer gripping units 16 may be provided.

Each gripping unit 16 comprises a lifting piston 18 (see FIGS. 5A and 5B, not visible in FIG. 1) and a gripper 20 coupled in motion to the lifting piston 18 for gripping an object 21 (see FIG. 5B).

As explained in more detail below, the lifting piston 18 can be displaced along a lifting axis 22 between an axially retracted configuration and an axially extended configuration.

In the specific example, the lifting piston 18 of a respective gripping unit 16 can be transferred from the retracted configuration to the extended configuration by applying compressed air. For this purpose, each gripper block 12 comprises a compressed air distribution system 24, via which the lifting pistons 18 can be supplied with compressed air (described in detail below). The compressed air distribution system 24 forms a first operating fluid distribution system 26 of the gripper block 12.

In embodiments not shown, the lifting piston 18 can, additionally or alternatively, also be transferable from the retracted configuration to the extended configuration by applying negative pressure.

In the example shown, the grippers 20 are designed as suction grippers 26. In this respect, the gripping units 16 are suction units and the gripper blocks 10 are suction blocks. In embodiments not shown, however, it is also conceivable that the grippers 20 or at least a subset of the grippers 20 comprise other gripping mechanisms.

In the example according to FIG. 1, the suction grippers 26 are each formed by a suction body 28, in particular an elastomer suction body. In the exemplary configuration according to FIG. 1, the suction grippers 26 (suction bodies 28) are also identical to one another. In embodiments not shown, the type and size of the suction grippers 26 may also vary. For example, it is conceivable that suction bodies 28 of different sizes are provided on different gripping units 16.

As explained in detail below, the suction grippers 26 can be supplied with negative pressure via a negative pressure channel 30 formed in the respective lifting piston 18. The negative pressure channel 30 can in turn be supplied with negative pressure via a negative pressure distribution system 32. For example, a separate negative pressure distribution system 32 is provided for each gripping unit 16. However, it is also possible for the gripping units 16 to be supplied with negative pressure via a common negative pressure distribution system 32. The negative pressure distribution system 32 forms a second operating fluid distribution system 26 of the gripper block 10.

A negative pressure supply to the negative pressure channel 30 and thus a negative pressure supply to the suction gripper 26 is preferably controlled via an optional shut-off device 34 such that in the retracted configuration of the lifting piston 18, a flow path between the negative pressure channel 30 and the negative pressure distribution system 32 and thus between the suction gripper 26 and the negative pressure distribution system 32 is blocked (passive configuration) and in the extended configuration of the lifting piston 18, this flow path is released (active configuration).

As mentioned above, the intermediate piece 12 serves as a coupling piece for the transmission of operating fluid between two adjacent gripper blocks 10. In the specific example with compressed air distribution system 24 and negative pressure distribution system 32, the intermediate piece 12 is designed to transmit both compressed air and negative pressure between two gripper blocks 10 coupled by the intermediate piece 12.

In the example, the gripper blocks each have an intermediate piece coupling point 38-1, 38-2 on two opposite coupling sides 36-1, 36-1 for coupling an intermediate piece 12.

In the assembled state of the gripping apparatus 300, the intermediate piece 12 is then coupled with a first coupling side 39-1 to the intermediate piece coupling point 38-1, 38-2 of a first gripper block 10 and with a second coupling side 39-2 to the intermediate piece coupling point 38-1, 38-2 of a further gripper block 10.

In this way, gripping apparatuses 300 with different extents can be easily realized by arranging, one behind the other, gripper blocks 10 and intermediate pieces 12 arranged therebetween.

In embodiments not shown, however, it is also conceivable in principle that a respective gripper block 10 has only a single intermediate piece coupling point and on the opposite side (instead of a further intermediate piece coupling point) the intermediate piece 12 is molded onto the main body 14, for example by injection molding.

In the example, the intermediate piece coupling points 38-1, 38-2 are identical to one another and, accordingly, the coupling sides 39-1, 39-2 of the intermediate piece 12 are identical to one another. To simplify readability, reference is therefore made below only to the intermediate piece coupling point 38-1 visible in FIG. 1 and its interaction with the intermediate piece 12. However, the statements also apply analogously to the other intermediate coupling points.

As can be seen from FIG. 1, the intermediate piece coupling point 38-1 is formed on the main body 14. The intermediate piece coupling point 38-1 is, by way of example and preferably, designed as an intermediate piece receptacle 40 for inserting the intermediate piece 12 (cf. FIG. 2).

A bottom surface 42 of the intermediate piece receptacle 40 forms a contact surface 44 for the intermediate piece in the coupled state.

The intermediate piece receptacle 40 and the intermediate piece 12 are preferably dimensioned such that, in an assembled state, the main bodies 14 of adjacent gripper blocks 10 abut one another (see FIG. 3). The intermediate piece 12 is thus received in the two intermediate piece receptacles 40 of the gripper blocks 10.

As can be seen from FIG. 1, the negative pressure distribution systems 32 each open out at the contact surface 44 with a negative pressure opening 46. In the example, the compressed air distribution system 24 also opens out into the contact surface 44 with a compressed air opening 48.

The intermediate piece 12 has an operating fluid channel for each of the operating fluid openings (negative pressure openings 46 and compressed air opening 48). In the example, the intermediate piece 12 has two negative pressure channels 50 and one compressed air channel 52.

By way of example and preferably, the negative pressure channels 50 and the compressed air channel 52 are surrounded by a respective connecting pin 54 on each coupling side 39-1, 39-2 of the intermediate piece 12. As mentioned above, the connecting pins 54 are dimensioned such that the connecting pins 54 can be inserted into the associated operating fluid opening 46, 48 and thus a fluidic connection can be established (see FIG. 2).

To seal a respective fluidic connection, corresponding seals 56, for example in the form of O-rings surrounding the operating fluid channels (negative pressure channels 50 and compressed air channel 52), can be provided on the intermediate piece 12. For example, corresponding seal receptacles 58 for receiving the seals 56 can then be formed around the operating fluid openings 46, 48. However, in embodiments not shown, sealing can also be achieved in other ways.

In the example, the intermediate piece 12 also has an optional electrical interface 60. The electrical interface 60 can be designed to transmit data. In this respect, the electrical interface 60 can be a data interface. Alternatively or additionally, the electrical interface 60 can be designed to transmit current.

As can be seen from FIG. 1, an electrical coupling point 62 is provided accordingly at each of the intermediate piece coupling points 38-1, 38-2. The electrical interface 60 and the electrical coupling point 62 can in particular be designed as a plug connection.

As mentioned above, each gripper block 10 may have an optional control device (not shown) connected to the electrical coupling point 60. The control device can, for example, be arranged in a control device receptacle 64 of the main body 14.

In the example, the intermediate piece 12 also has optional fastening pins 66, which can be received, in particular inserted, in corresponding fastening receptacles 68 at the intermediate piece coupling point 38-1, 38-2.

It is fundamentally conceivable that the gripper blocks 10 are mechanically connected by the intermediate piece 12. In particular, however, a carrier plate (not shown in the figures), for example a flange plate for connection to a manipulator, in particular a robot, can be provided, to which the gripper blocks 10 are fastened. For this purpose, the main bodies 14 can optionally have corresponding fastening bolts 70.

In FIGS. 1 and 2, the main bodies 14 are shown open at the top. In the operating state, however, the main bodies 14 are covered at the top by a cover 72.

As can be seen from FIG. 1, the negative pressure distribution systems 32 each have a further supply opening 74 at the intermediate piece coupling points 38-1, 38-2 in addition to the negative pressure openings 46. The supply openings 74 can either be closed by a sealing plug 76 or can be provided with a connecting piece 78 for connection to an external negative pressure supply (e.g., blower, ejector or pump) (see FIG. 3).

As can be seen from FIGS. 3 and 4, intermediate piece coupling points 38-1, 38-2 which are not occupied by an intermediate piece 12 (e.g., the terminal intermediate piece coupling points of the gripping apparatus 300 according to FIG. 3) are covered by a cover piece 80, in particular in the form of a cover plate. The cover piece 80 is particularly designed to seal the operating fluid openings 46, 48. For example, the cover piece can be screwed to the main body 14 using corresponding fastening screws 82.

As mentioned above, the gripper blocks 10 can be designed identically to one another. In particular, however, it is conceivable that at least one gripper block 10 (in FIG. 3 the left gripper block) is designed as a feed block 90, which has corresponding connections to the outside. As can be seen from FIG. 4, the feed block 90 comprises a negative pressure connection 92 (connecting piece 78) connected to the negative pressure distribution system 32 for connection to an external negative pressure supply. The feed block 90 also has a compressed air connection 94 connected to the compressed air distribution system 24 for connection to an external compressed air supply. In addition, the feed block has a data and/or power connection 96 connected to the electrical coupling point 62 (e.g., with the interposition of a control device). As described above, negative pressure, compressed air and data/power can then be transmitted via the intermediate pieces 12 to the further gripper blocks 10 of a gripping apparatus 300.

An exemplary configuration of the gripping units 16, in particular a mode of operation of the lifting pistons 16, is explained below with reference to FIGS. 5A and 5B.

As can be seen from FIG. 5A, the lifting pistons 16 are guided in a respective gripping unit housing 98 so as to be displaceable along the lifting axis 22. In the example, the gripping unit housing 98 is designed in several parts and comprises a first upper portion 100, which is formed by the main body 14, and a second, lower portion 102, which is provided by an attachment 104 connected to the main body 14. In embodiments not shown, the gripping unit housing 98 can also be formed in one piece and held on the main body 14.

The gripping unit housing 98 defines a housing interior 106 in which the lifting piston 18 is guided displaceably along the lifting axis 22.

In the example, the lifting piston 18 is biased into the retracted configuration by means of an optional spring device 108. The spring device 108 comprises a compression spring 110. The compression spring 110 is supported with a first end on a housing inner wall of the gripping unit housing 98 (in the example on a housing inner wall of the lower portion 102/attachment 104) and with the second end on a first end face 112 of a radial projection 114 of the lifting piston 18 (for the sake of clarity, only a part of the spring 110 is shown in the figures).

The end face 112 of the radial projection 114 preferably serves as a stop in order to limit a displacement movement of the lifting piston 18 in the extension direction when it rests against a shoulder 116 of the inner wall of the gripping unit housing 98 (see FIG. 5B). The radial projection 114 defines the extended configuration (end position).

In order to extend the lifting piston 18 from the retracted configuration—counter to the spring loading in the extension direction 116—a positive pressure chamber 118 is formed in the housing interior 106, by applying compressed air to which a force acting in the extension direction 116 is exerted on the lifting piston 18. In the specific example, the lifting piston 18 delimits the positive pressure chamber 118 with an end face 122 of the radial projection 114 oriented in a retraction direction 120. In this respect, a positive pressure prevailing in the positive pressure chamber 118 acts on the radial projection 114.

The positive pressure chamber 118 can be supplied with compressed air via the above-mentioned compressed air distribution system 24. To control a compressed air supply to the positive pressure chamber 118 and thus a displacement of the lifting piston 118 in the extension direction 116, the gripper block 10 also has a valve device 124, by means of which a fluidic connection between the compressed air distribution system 24 and the positive pressure chamber 118 can be selectively blocked or released. In particular, a separate valve device, in particular a separate compressed air valve, is provided for each gripping unit 16.

As mentioned above, the gripper block 10 may optionally also have an integrated control device (not shown) for controlling the valve device(s).

As mentioned above, the lifting piston 16 has an internal negative pressure channel 30 via which the suction gripper 26 can be supplied with negative pressure.

In the example, the negative pressure channel 30 is supplied with negative pressure via a first negative pressure chamber 126 formed in the housing interior 106. The negative pressure chamber 126 is connected to the above-mentioned negative pressure distribution system 32 via a chamber opening 128.

As can be seen from FIG. 5A, the chamber opening 128 is sealed in the axially retracted configuration (passive configuration) by a first sealing device 130 arranged on the lifting piston 18, so that a negative pressure supply to the first negative pressure chamber 126 and thus to the negative pressure channel 30 and thus to the suction gripper 26 is blocked. By displacing the lifting piston 18 in the extension direction 116 (e.g., by supplying compressed air to the positive pressure chamber 118), the first sealing device 130 is lifted from the chamber opening 128 so that negative pressure can flow via the negative pressure distribution system 32 into the first negative pressure chamber 126 and from there via a radial supply channel 132 into the negative pressure channel 30. In the extended configuration, the suction gripper 26 then assumes an active configuration in which the suction gripper 26 is supplied with negative pressure and can thus suck against an object.

In this respect, by acting on the positive pressure chamber 118, on the one hand, an extension of the lifting piston 18 in the extension direction 116 is effected and, at the same time, a negative pressure supply to the suction gripper 26 is opened. The valve device 124 therefore controls two functions.

The gripping units 16 shown in FIGS. 5A and 5B are optionally designed such that the lifting piston 18 is acted upon by the effect of the negative pressure in the extension direction 116 when the chamber opening 128 of the first negative pressure chamber 126 is opened. This self-holding function, which is described in more detail below, is advantageous but not essential for the design according to the invention.

As can be seen, for example, from FIG. 5B, the lifting piston 18 is designed such that it divides the housing interior 106 into the first negative pressure chamber 126, a second negative pressure chamber 134 and the above-mentioned positive pressure chamber 118, wherein the positive pressure chamber 118 is arranged in the example between the first negative pressure chamber 128 and the second negative pressure chamber 134. The chambers 118, 126, 134 can be changed in size by changing a displacement position of the lifting piston 18 along the lifting axis 22.

In the specific example, the lifting piston 18 separates a region of the first housing interior 106 by means of a second sealing device 136, which region forms the first negative pressure chamber 126. The above-mentioned radial projection 114 in turn separates a portion of the housing interior 106 arranged behind it in the extension direction 116 into the positive pressure chamber 118 and the second negative pressure chamber 134. A third sealing device 138, for example in the form of an O-ring, is provided to seal the positive pressure chamber 118 from the second negative pressure chamber 145.

The first negative pressure chamber 126 and the second negative pressure chamber 134 are fluidically connected to one another via the negative pressure channel 30, so that the second negative pressure chamber 134 can be supplied with negative pressure via the first negative pressure chamber 126. In particular, the same pressure always prevails in the first negative pressure chamber 126 and in the second negative pressure chamber 134.

If the positive pressure chamber 118 is supplied with compressed air at least for a short time, the compressed air acts on the lifting piston 18, so that the lifting piston 18 is moved in the extension direction 116 against the spring loading by the compression spring 110 and thus the chamber opening 128 is opened as described above. As a result, negative pressure is passed into the first negative pressure chamber 126 and finally via the negative pressure channel 30 into the second negative pressure chamber 134 (and further into the suction gripper 26).

The negative pressure chambers 126, 134 and the lifting piston 18 are dimensioned such that the negative pressure then present in the negative pressure chambers 126, 134 exerts a force acting in the extension direction 116 on the lifting piston 18. In the example, this is achieved in that the lifting piston 16 has first surface portions 140 which are oriented in such a way that the negative pressure prevailing in the negative pressure chambers 126, 134 acting on the first surface portions 140 exerts a force acting in the extension direction 116 on the lifting piston 18. In the example, such first surface portions 140 are formed, for example, by the end face 112 of the radial projection 114 oriented in the extension direction 116.

In addition, second surface portions 142 are provided (see FIG. 5B), which are oriented such that the negative pressure prevailing in the negative pressure chambers 126, 134 acting on the second surface portions 142 exerts a force acting in the retraction direction 120 on the lifting piston 18. In the example, such second surface portions 142 are formed, for example, by the axial end surfaces of the lifting piston 18, which delimit the first negative pressure chamber 126 (see FIG. 2B).

A sum of all first surface portions 140 is greater than a sum of all second surface portions 142, so that a net force acts on the lifting piston 18 in the extension direction 116.

1. A gripper set, comprising
at least two gripper blocks, each including a main body with at least one integrated operating fluid distribution system for distributing operating fluid and at least one gripping unit held on the main body, which gripping unit can be supplied with operating fluid via the operating fluid distribution system, wherein the gripping unit includes a lifting piston that can be extended and retracted along a lifting axis and a gripper or a suction gripper, which is coupled in motion to the lifting piston and is used to grip an object,
at least one intermediate piece for transmitting operating fluid between the gripper blocks, wherein
each gripper block has an intermediate piece coupling point for coupling an intermediate piece on one coupling side, or on two opposite coupling sides in each case,
an operating fluid opening of the at least one operating fluid distribution system opens out at the intermediate piece coupling point, and
the intermediate piece has an operating fluid channel such that the operating fluid channel is fluidically connected to the operating fluid opening in the coupled state of the intermediate piece at the intermediate piece coupling point.

2. The gripper set according to claim 1, wherein the intermediate piece coupling point is designed as an intermediate piece receptacle into which the intermediate piece can be inserted or plugged at least in portions.

3. The gripper set according to claim 2, wherein the intermediate piece receptacle has a contact surface for contacting the intermediate piece, wherein the at least one operating fluid opening opens out into the contact surface.

4. The gripper set according to claim 3, wherein the operating fluid channel is surrounded by a connecting pin which can be inserted into the operating fluid opening.

5. The gripper set according to claim 4, wherein the intermediate piece is designed such that the operating fluid channel is sealed by inserting the connecting pin into the operating fluid opening.

6. The gripper set according to claim 1, wherein the intermediate piece further comprises an electrical interface for transmitting data and/or power between the gripper blocks connected by the intermediate piece.

7. The gripper set according to claim 6, wherein an electrical coupling point for interacting with the electrical interface of the intermediate piece is also provided at the intermediate piece coupling point.

8. The gripper set according to claim 7, wherein each gripper block has a control device, wherein the control device is connected to the electrical coupling point of the respective gripper block electrically and/or for data exchange.

9. The gripper set according to claim 1, wherein the intermediate piece has sensors for monitoring a gripping state of the at least one gripping unit of a gripper block connected to the intermediate piece, a pressure sensor for detecting an operating pressure prevailing in an operating fluid channel.

10. The gripper set according to claim 1, further comprising at least one cover piece, in the form of a cover plate, which is designed to cover an intermediate piece coupling point not occupied by an intermediate piece, and wherein the cover piece is designed to seal the at least one operating fluid opening.

11. The gripper set according to claim 1, wherein the respective main body of the gripper blocks is constructed monolithically.

12. The gripper set according to claim 1, the gripper being designed as a suction gripper for sucking against an object, wherein the at least one operating fluid distribution system comprises at least one negative pressure distribution system, and a compressed air distribution system, wherein at least one negative pressure opening of the at least one negative pressure distribution system, and at least one compressed air opening of the compressed air distribution system open at the intermediate piece coupling point, wherein the intermediate piece has at least one negative pressure channel and at least one compressed air channel.

13. The gripper set according to claim 1, wherein the intermediate piece has at least one negative pressure channel, at least one compressed air channel and at least one electrical interface.

14. A gripping apparatus, assembled from at least one gripper set according to claim 1, comprising said two gripper blocks which are coupled to one another via said intermediate piece, wherein the intermediate piece is coupled to an intermediate piece coupling point of the first gripper block, and wherein the intermediate piece is coupled to an intermediate piece coupling point of the second gripper block.

15. The gripping apparatus according to claim 14, further comprising a third gripper block which is coupled to the second gripper block via a second intermediate piece, wherein at least one operating fluid channel, at least the at least one negative pressure channel, of the second intermediate piece is closed in a fluid-tight manner.

16. The gripper set according to claim 1, wherein the operating fluid is negative pressure and/or positive pressure.
